(19) United States
(12) Patent Application Publication
(10) Pub. No.: US 2023/0371692 A1
(43) Pub. Date: Nov. 23, 2023

(54) Wooden dining chair

(71) Applicant: IGO FURNITURE (GAO AN) LIMITED, Yichun (CN)

(72) Inventor: CHI-PO LAW, Yichun (CN)

(21) Appl. No.: 17/858,316

(22) Filed: Jul. 6, 2022

(30) Foreign Application Priority Data
May 17, 2022 (CN) 202221191844.5

(51) Int. Cl. A47C 4/03; F16B 12/10

(52) U.S. Cl. CPC A47C 4/03; F16B 12/10; F16B 2012/106

(57) ABSTRACT

The invention provides a wooden dining chair, comprising a seat plate, a bottom of the seat plate is fixedly mounted with support legs, the surface of the seat plate is provided with a backrest, and the bottom of the seat plate is provided with accommodating holes, and fixing bolts are sleeved inside the accommodating holes. According to the invention, by arranging the backrest, when the entire chair needs to be assembled, the backrest is attached to the seat plate so that the nut can be aligned with the accommodating hole, and then the fixing bolt is screwed into the nut through the accommodating hole, and the backrest can be fixed, and then the whole chair can be used normally, and when the whole chair needs to be transported again, you can unscrew the fixing bolts and remove the backrest, so that the backrest can be knocked down.

### 1. TECHNICAL FIELD

The invention relates to the technical field of seats, in particular to a wooden dining chair.

### 2. BACKGROUND ART

Dining chairs are commonly used furniture, mostly wood. They are often used in conjunction with dining tables and are convenient for users to eat. However, most of the existing wood dining chairs are fixed by a tenon-and-mortise structure. It is often difficult to be disassembled, which makes it difficult to disassemble for transportation during transportation, which requires a large space and high cost. At the same time, it is inconvenient for users to store and transport when moving, and it is difficult to achieve a better use effect.

### 3. SUMMARY OF THE INVENTION

The purpose of the invention is to propose a wooden dining chair in order to solve the shortcomings existing in the prior art.

In order to achieve the above purpose, the invention adopts the following technical solutions: a wooden dining chair, comprising a seat plate, the bottom of the seat plate is fixedly installed with supporting legs, the surface of the seat plate is provided with a backrest, the seat plate the bottom of the board is provided with an accommodating hole, the interior of the accommodating hole is sleeved with a fixing bolt, the bottom of the backrest is provided with a limiting groove, and a nut is fixedly installed in the interior of the limiting groove, and the nut is engaged with the fixing bolt.

In order to facilitate the assembly of the backrest, the improvement of the present invention is that the backrest is composed of a bottom frame, a top frame and several vertical rods, and the two ends of the vertical rods are respectively fixedly connected with the bottom frame and the top frame.

In order to make the vertical rods fit the waist, the improvement of the present invention is that the shape of the vertical rod is cylindrical, the two ends are thin and the middle is thick, and the vertical rods are distributed at equal intervals.

In order to fit the backrest to the back, the improvement of the present invention is that the shapes of the bottom frame and the top frame are circular arc.

In order to prevent the user from colliding with the seat plate and being injured, the improvement of the present invention is that the edge of the surface of the seat plate is provided with rounded corners.

In order to fix the backrest stably, the improvement of the present invention is that the fixing bolts are distributed symmetrically.

Compared with the prior art, the advantages and positive effects of the present invention are.

In the present invention, by arranging the backrest, when the entire chair needs to be assembled, the backrest is attached to the seat plate so that the nut can be aligned with the accommodating hole, and then the fixing bolt is screwed into the nut through the accommodating hole, and the backrest can be assembled, then the entire chair can be used normally, and when the entire seat needs to be transported again, the fixing bolts can be unscrewed and the backrest can be removed, thereby reducing the space occupied by the entire chair, which is convenient for the user to transport, and the whole process is simple to operate and convenient for the user to use.

### 4. BRIEF DESCRIPTION OF ACCOMPANY DRAWINGS

FIG. 1 is the overall structure schematic diagram that the invention proposes a kind of wooden dining chair.

FIG. 2 is the structural schematic diagram of the upward view of a wooden dining chair proposed by the invention.

FIG. 3 is an exploded view of a wooden dining chair proposed by the invention.

FIG. 4 is a schematic structural diagram of the wooden dining chair in FIG. 3 at the position A of the present invention.

Wherein:

1—Seat plate, 2—Supporting legs, 3—Backrest, 4—Accommodating hole, 5—Fixing bolt, 6—Nut, 7—Bottom frame, 8—Top frame, 9—Vertical rods.

### 5. SPECIFIC EMBODIMENT OF THE INVENTION

In order to be able to understand the above-mentioned objects, features and advantages of the present invention more clearly, the present invention will be further described below with reference to the accompanying drawings and embodiments. It should be noted that the embodiments of the present application and the features in the embodiments may be combined with each other in the case of no conflict.

In the description of the invention, it should be understood that the terms “length”, “width”, “upper”, “lower”, “front”, “rear”, “left”, “right”, “vertical”, “horizontal”, “top”, “bottom”, “inside”, “outside” and other indicated orientations or positional relationships are based on the orientations or positional relationships shown in the accompanying drawings, only for the convenience of describing the present invention and simplifying the description, rather than indicating or implying that the indicated device or element must have a particular orientation, be constructed and operate in a particular orientation, it should not be construed as a limitation of the present invention. In addition, in the description of the present invention, “plurality” means two or more, unless otherwise expressly and specifically defined.

### Embodiment

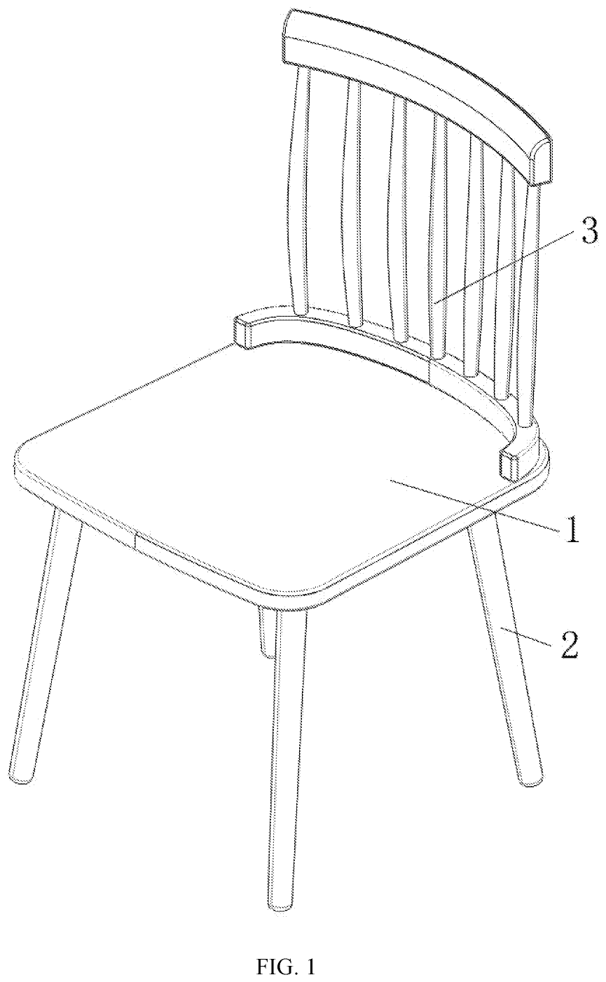

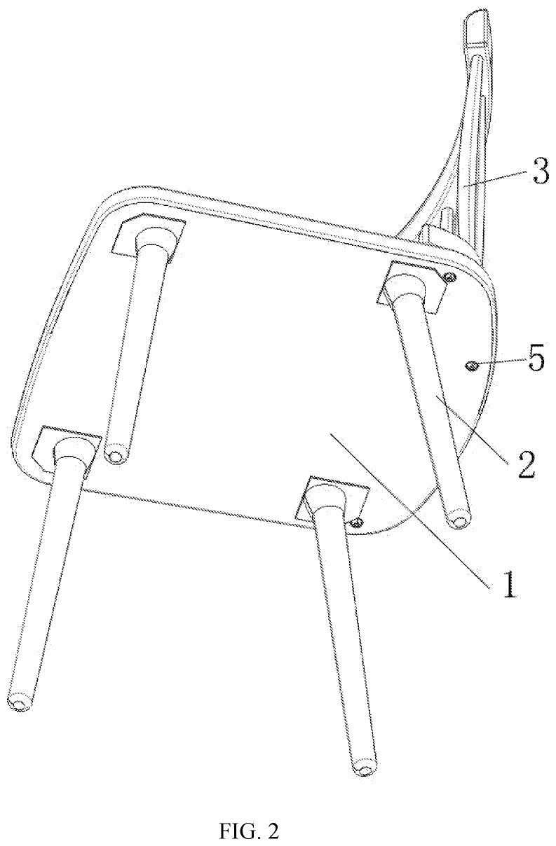

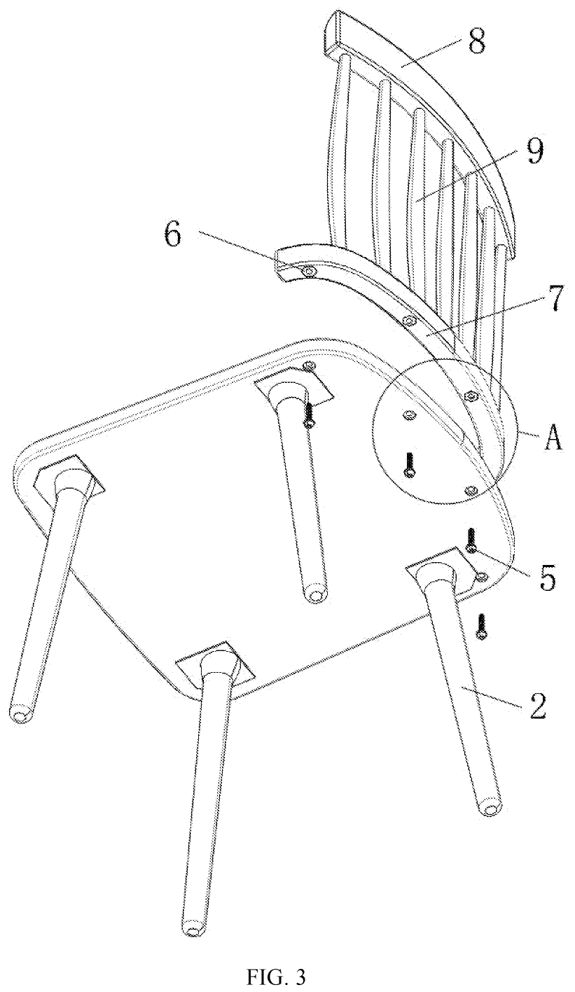

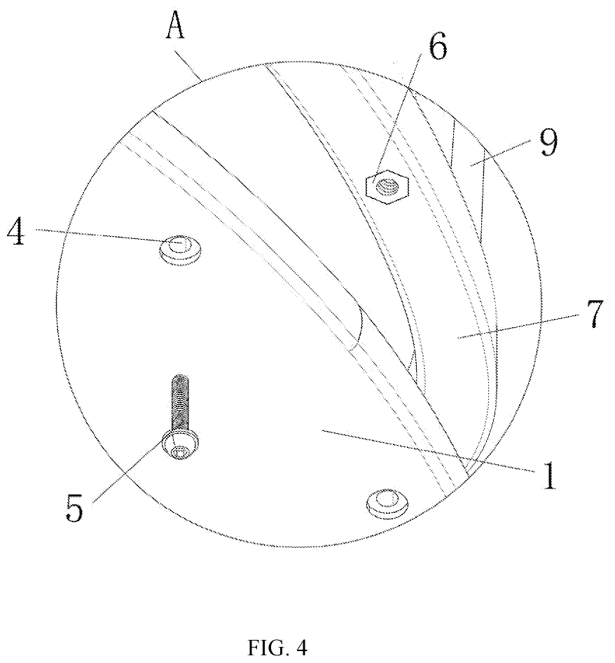

As shown in FIG. 1-4, the present invention provides a technical solution: a wooden dining chair, comprising a seat plate 1, the bottom of the seat plate 1 is fixedly installed with support legs 2, and the surface of the seat plate 1 is provided with a backrest 3, the bottom of the seat plate 1 is provided with an accommodating hole 4, the interior of the accommodating hole 4 is set with a fixing bolt 5, the bottom of the backrest 3 is provided with a limiting groove, and the interior of the limiting groove is fixedly installed with a nut 6, the nut 6 and the fixing bolt 5 When the entire seat needs to be assembled, fit the backrest 3 to the seat plate 1 so that the nut 6 can be aligned with the accommodating hole 4, and then screw the fixing bolt 5 through the accommodating hole 4 into the nut 6, and then the backrest 3 After fixing, the whole chair can be used normally, and when the whole chair needs to be transported again, the fixing bolts 5 can be unscrewed and the backrest 3 can be removed, thereby reducing the space occupied by the entire chair, so that the user can transport it. The whole process is simple to operate and convenient for the user to use.

As shown in FIG. 1-4, the backrest 3 is composed of a bottom frame 7, a top frame 8 and several vertical rods 9. Both ends of the vertical rod 9 are fixedly connected to the bottom frame 7 and the top frame 8 respectively. The shape of the vertical rod 9 is cylindrical, and the two ends are thin and the middle is thick, the vertical rods 9 are equally spaced, the shapes of the bottom frame 7 and the top frame 8 are arc-shaped, and the arc-shaped bottom frame 7 and the top frame 8 can fit the user's back, and the vertical rods 9 with thin at both ends and thick in the middle can fit the waist of the user, so that the user can lean on comfortably.

Working principle: When in use, when the user needs to assemble the entire chair, he only needs to pick up the backrest 3, fit the bottom frame 7 to the seat plate 1, so that the nut 6 can be aligned with the accommodating hole 4, and then the fixing bolt 5 can be insert into the accommodating hole 4, and screw the fixing bolt 5 into the nut 6 by tightening the fixing bolt 5, the bottom frame 7 and the seat plate 1 can be fixed together, and the entire chair can be used normally, the bottom frame 7 and the top frame 8 can fit the back of the user, and the vertical rods 9 with thin ends and thick middle can fit the waist of the user, so that the user can lean on comfortably. When the whole chair needs to be transported again, the fixing bolts 5 can be unscrewed and the backrest 3 can be removed, thereby reducing the space occupied by the entire chair and facilitating transportation by the user.

The above are only preferred embodiments of the present invention, and are not intended to limit the present invention in other forms. Any person skilled in the art may use the technical content disclosed above to be changed or modified to be equivalent to equivalent changes. The embodiments are applied in other fields, but any simple modifications, equivalent changes and modifications made to the above embodiments according to the technical essence of the present invention still belong to the protection of the technical solutions of the present invention without departing from the technical solutions of the present invention. scope.

1. A wooden dining chair, comprising a seat plate, characterized in that: the bottom of the seat plate is fixedly installed with support legs, and the surface of the seat plate is provided with a backrest, the bottom of the seat plate is provided with an accommodating hole, the interior of the accommodating hole is sleeved with a fixing bolt, and the bottom of the backrest is provided with a limited position nut which is fixedly installed inside the limiting groove, and the nut is engaged with the fixing bolt.

2. The wooden dining chair according to claim 1, characterized in that: the backrest is composed of a bottom frame, a top frame and a vertical rod, and the vertical rod is composed of the two ends are respectively fixedly connected with the bottom frame and the top frame.

3. The wooden dining chair according to claim 2, characterized in that: the vertical rods are cylindrical in shape, and the two ends are thin and the middle is thick, and the vertical rods are equally spaced.

4. The wooden dining chair according to claim 2, wherein the bottom frame and the top frame are both arc-shaped.

5. The wooden dining chair according to claim 1, characterized in that: the edge of the surface of the seat plate is provided with rounded corners.

6. The wooden dining chair according to claim 1, wherein the fixing bolts are symmetrically distributed.
